(19) United States
(12) Patent Application Publication
(10) Pub. No.: US 2002/0138404 A1
(43) Pub. Date: Sep. 26, 2002

(54) Mas trading system and method

(76) Inventors: Tatsuo Akiyama, Tokyo (JP); Katsuya Okumura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/078,394

(22) Filed: Feb. 21, 2002

(30) Foreign Application Priority Data
Mar. 26, 2001 (JP) 2001-087470

(51) Int. Cl. G06F 17/60; G06G 7/00; G06F 17/00

(52) U.S. Cl. 705/37

(57) ABSTRACT

A system for trading a photo mask includes a purchase mediating section configured to exchange information with a mask buyer through a network, and a factory mediating section configured to exchange information with a mask factory. The system also includes a calculating section, a progress selecting section, and a manufacture instructing section. The calculating section calculates an estimated price and an estimated delivery date of a mask product with reference to line information about a manufacturing line in the mask factory, and price information about mask trading prices. The progress selecting section transmits the estimated price and the estimated delivery date to the mask buyer and allows the mask buyer to select whether to proceed with manufacture of the mask. The manufacture instructing section transmits the mask manufacture order to the mask factory, when proceeding with manufacture of the mask is selected.

### CROSS-REFERENCE TO RELATED APPLICATIONS

This application is based upon and claims the benefit of priority from the prior Japanese Patent Application No. 2001-087470, Mar. 26, 2001, the entire contents of which are incorporated herein by reference.

### BACKGROUND OF THE INVENTION

1. Field of the Invention

The present invention relates to a mask trading system and method for trading through a network a photo mask used for manufacturing semiconductor devices.

2. Description of the Related Art

In general, trading of a photo mask used for manufacturing semiconductor devices proceeds basically as follows: First, a mask buyer gives a written order to a mask manufacturer. The written order contains various information, such as design specifications, quantity, desired delivery date, and examination specifications of the mask. The mask manufacturer manufactures the ordered mask in a factory in accordance with the written order. Then, the mask manufacturer examines the manufactured mask product. If the examination data of the product does not conform to the specifications in the written order, the mask manufacturer re-manufactures the mask. In such a manner, the mask manufacturer repeats the manufacture and examination of the mask until a manufactured mask product conforms to the specifications in the written order. Then, the final mask product is delivered to the buyer.

### BRIEF SUMMARY OF THE INVENTION

According to a first aspect of the present invention, there is provided a system for trading a photo mask used for manufacturing semiconductor devices, comprising:

a purchase mediating section configured to exchange information with a mask buyer through a network;

a factory mediating section configured to exchange information with a mask factory;

a manufacture order storing section configured to store a mask manufacture order, which is inputted through the purchase mediating section, and includes at least one of design specifications, a quantity, a desired delivery date, and examination specifications of a mask;

a line information storing section configured to store line information, which is inputted through the factory mediating section, and includes a processing ability state of a manufacturing line in the mask factory;

a price information storing section configured to store price information, which includes relationships between contents of mask manufacture orders and mask trading prices;

a calculating section configured to calculate an estimated price and an estimated delivery date of a mask product with reference to the price information and the line information, in response to the mask manufacture order;

a progress selecting section configured to transmit the estimated price and the estimated delivery date to the mask buyer through the purchase mediating section, and allow the mask buyer to select whether to proceed with manufacture of the mask or not; and

a manufacture instructing section configured to transmit the mask manufacture order to the mask factory through the factory mediating section, when proceeding with manufacture of the mask is selected.

According to a second aspect of the present invention, there is provided a mask trading method of trading a photo mask used for manufacturing semiconductor devices, using a system including a purchase mediating section configured to exchange information with a mask buyer through a network, and a factory mediating section configured to exchange information with a mask factory, the method comprising:

storing a mask manufacture order, which is inputted through the purchase mediating section, and includes at least one of design specifications, a quantity, a desired delivery date, and examination specifications of a mask;

storing line information, which is inputted through the factory mediating section, and includes a processing ability state of a manufacturing line in the mask factory;

storing price information, which includes relationships between contents of mask manufacture orders and mask trading prices;

calculating an estimated price and an estimated delivery date of a mask product with reference to the price information and the line information, in response to the mask manufacture order;

transmitting the estimated price and the estimated delivery date to the mask buyer through the purchase mediating section, and allowing the mask buyer to select whether to proceed with manufacture of the mask or not; and

transmitting the mask manufacture order to the mask factory through the factory mediating section, when proceeding with manufacture of the mask is selected.

### BRIEF DESCRIPTION OF THE SEVERAL VIEWS OF THE DRAWING

FIG. 1 is a block diagram showing the relationship within a system for trading a photo mask used for manufacturing semiconductor devices, terminal units on a mask buyer side, and a mask factory, according to an embodiment of the present invention;

FIG. 2 is a flowchart showing a business flow of a mask trading method performed by the system shown in FIG. 1;

FIG. 3 is a flowchart showing a system flow of the mask trading method performed by the system shown in FIG. 1;

FIG. 4 is a view showing a screen picture displayed for a mask buyer to input a mask manufacture order;

FIG. 5 is a view showing a screen picture displayed for a mask buyer to select whether to proceed with manufacture of the mask or not;

FIG. 6 is a view showing a screen picture displayed for the mask buyer, when examination results on a mask product conform to examination specifications set out in the mask manufacture order;

FIG. 7 is a view showing a screen picture displayed for the mask buyer, when examination results on a mask product do not conform to examination specifications set out in the mask manufacture order; and

FIG. 8 is a view showing another screen picture displayed for the mask buyer, when examination results on a mask product do not conform to examination specifications set out in the mask manufacture order.

### DETAILED DESCRIPTION OF THE INVENTION

In the process of developing the present invention, the present inventors studied the conventional mask trading method described above. As a result, the present inventors have obtained the following findings.

Under the current state of affairs, a mask product is judged as to whether it is good or not, on the basis only of the dimensions and number of defects formed in the mask product. Accordingly, as the present inventors have found, some mask products acceptable in practice may be judged to be inferior goods in the following two cases. Namely, one of them is a case where defects in a mask product are not transferred onto a semiconductor wafer in a semiconductor manufacturing process. The other is a case where defects in a mask product are transferred onto a semiconductor wafer in a semiconductor manufacturing process, but cause no problems in the performance of a semiconductor device.

In general, several tens of defects are detected on one mask product in examination performed after it is manufactured in a mask factory. As a mask pattern is downsized, the defect specifications become stricter and the yields of mask products become lower. As a result, a sequence of mask manufacture, mask examination, and mask re-manufacture is sometimes repeated within a mask manufacturer side. It follows that, a mask buyer cannot know when the buyer receive the ordered mask, while a mask manufacturer produces a lot of inferior goods, thereby falling into a busy state without profit.

In addition, after the buyer places an order, information regarding an estimated price and an estimated delivery date is sometimes long in coming from a mask manufacturer. This not only wastes time, but also makes it more difficult for the buyer to choose the most suitable mask manufacturer.

Accordingly, it is preferable to better the communication between a mask buyer and a mask factory, so as to shorten the period from a mask order to a mask product delivery. It is also preferable to better the communication between a mask buyer and a mask factory, so as to prevent such wastage in which mask products having non-serious defects are scraped.

Embodiments of the present invention achieved on the basis of the findings given above will now be described with reference to the accompanying drawings. In the following description, the constituent elements having substantially the same function and arrangement are denoted by the same reference numerals, and a repetitive description will be made only when necessary.

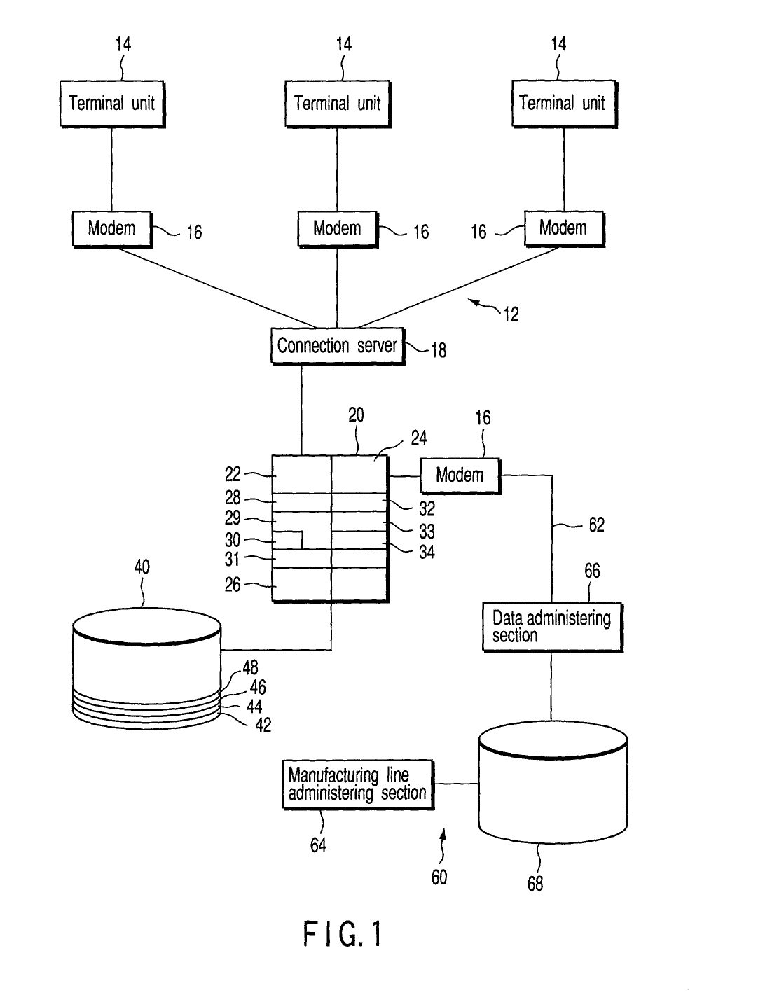

FIG. 1 is a block diagram showing the relationship within a system for trading a photo mask used for manufacturing semiconductor devices, terminal units on a mask buyer side, and a mask factory, according to an embodiment of the present invention.

In this embodiment, a host apparatus (imaginary factory) 20 of the mask trading system is disposed at site accessible by a user's terminal unit 14, such as a personal computer, through a network 12, particularly through the transmission lines of the Internet (public communication network). Accordingly, the host apparatus 20, i.e., a host computer (including a web server, application server, and database server), has a purchase agent (purchase mediating section) 22, which is connected to the network 12 and used as a window to exchange information with a mask buyer. The host apparatus 20 also has a factory agent (factory mediating section) 24, which is connected to an exclusive line 62 to the mask factory 60 and used as a window to exchange information with the mask factory 60. Reference symbols 16 and 18 in FIG. 1 denote modems and a connection server, respectively.

The host apparatus 20 is provided with a database 40, in which a manufacture order file 42, a line information file 44, a price information file 46, an examination data file 48, and so forth are formed. The manufacture order file 42 is used to store a mask manufacture order, which includes the design specifications, quantity, desired delivery date, examination specifications, and so forth of an ordered mask, and is inputted through the purchase agent 22. Where product names or product numbers of masks are set 5 in advance between a mask buyer and the mask factory 60, the product names or product numbers of masks can be used as information representing mask specifications. The line information file 44 is used to store line information, which includes the state of the processing abilities of manufacturing lines in the mask factory 60, and is inputted through the factory agent 24, as required. The price information file 46 is used to store price information, which includes the relationships between the contents of mask manufacture orders and mask trading prices.

The examination data file 48 is used to store the examination data of a mask product manufactured in the mask factory 60, which is inputted through the factory agent 24. The examination data includes the coordinate positions and dimensions of defects generated in the mask product, and, if necessary, further includes the number of defects and image data thereof. Furthermore, the examination data may include an optical simulation image to be formed when the mask product is used for a wafer. The contents of the examination data can be suitably changed, depending on, e.g., examination specifications set out in a mask manufacture order inputted by a mask buyer.

In order to perform a first stage mediation between a mask buyer and the mask factory 60, utilizing the above-described information stored in the database 40, the host apparatus 20 has a calculating section 26, a progress selecting section 28, a manufacture instructing section 32, and so forth. The calculating section 26 calculates an estimated price and an estimated delivery date of a mask product with reference to the price information and the line information described above, in response to a mask manufacture order inputted through the purchase agent 22. The progress selecting section 28 transmits the estimated price and the estimated delivery date to the mask buyer through the purchase agent 22, and allows the buyer to select whether to proceed with manufacture of the mask or not. The manufacture instructing section 32 transmits the mask manufacture order to the mask factory 60 through the factory agent 24, when proceeding with manufacture of the mask is selected.

Furthermore, in order to perform a second stage mediation between the mask buyer and the mask factory 60, utilizing the above-described information stored in the database 40, the host apparatus 20 has an examination data transmitting section 34, a purchase selecting section 29, a re-manufacture selecting section 31, a re-manufacture instructing section 33, and so forth. The examination data transmitting section 34 transmits examination data to the mask buyer through the purchase agent 22. The purchase selecting section 29 allows the mask buyer through the purchase agent 22 to select, on the basis of the examination data, whether to buy the mask product or not. The purchase selecting section 29 also has a portion 30, which allows the mask buyer through the purchase agent 22 to input a desired purchase price of the mask product on the basis of the examination data. This portion 30 is effective, for example, where the mask product has defects but is acceptable. The re-manufacture selecting section 31 allows the mask buyer through the purchase agent 22 to select, on the basis of the examination data, whether to re-manufacture the mask or not. The re-manufacture instructing section 33 instructs re-manufacture of the mask to the mask factory 60 through the factory agent 24, when re-manufacture of the mask is selected.

In the mask factory 60, the mask manufacturing lines are administered by a manufacturing line administering section 64 formed of, e.g., a computer. The mask factory 60 is connected to the host apparatus 20 of the mask trading system only by a data administering section 66 formed of, e.g., a computer. The manufacturing line administering section 64 and the data administering section 66 are connected to a common factory database 68. The factory database 68 is used to store information transferred to and from the host apparatus 20 of the mask trading system, i.e., a mask manufacture order from a mask buyer, line information of the manufacturing lines, examination data of a mask product, and so forth.

The progress state of a mask being manufactured in accordance with a mask manufacture order may be inputted into the factory database 68 from the manufacturing line administering section 64, as required. In this case, the database 40 of the host apparatus 20 of the mask trading system may be provided with a corresponding file, so that the progress state of the mask being manufactured is transmitted from the data administering section 66 of the mask factory 60, and is stored in the database 40 of the host apparatus 20. With this arrangement, the mask buyer can be informed of the progress state of the mask being manufactured through the purchase agent 22, if necessary.

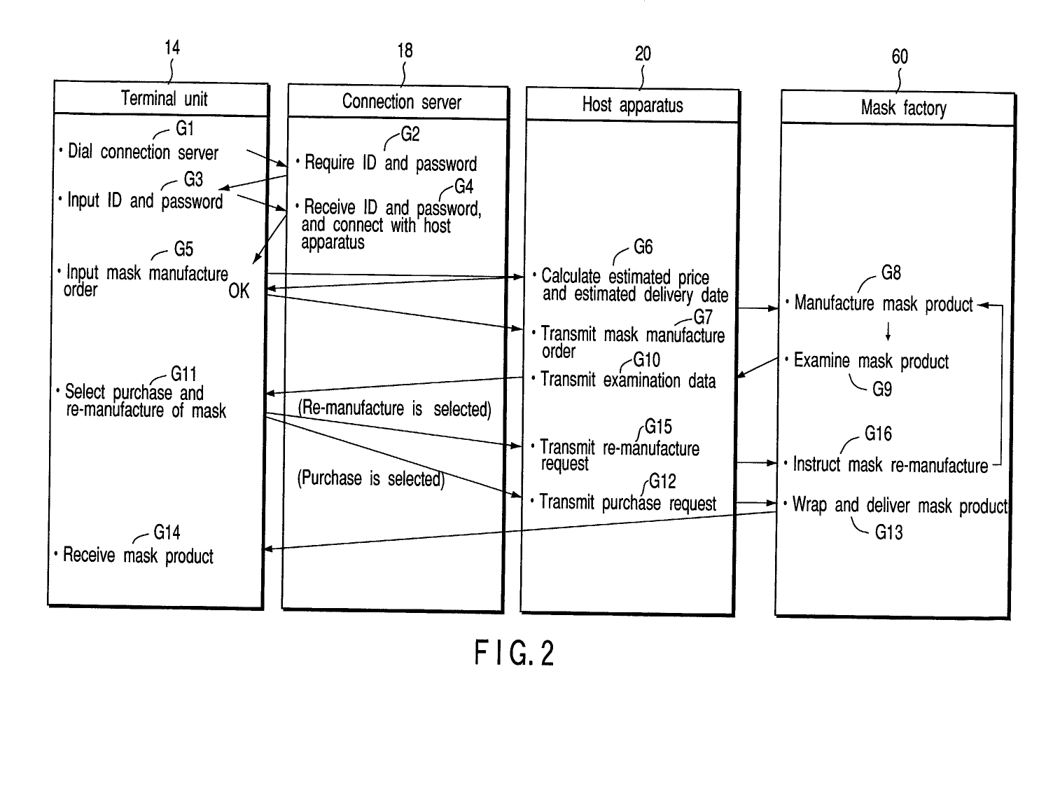

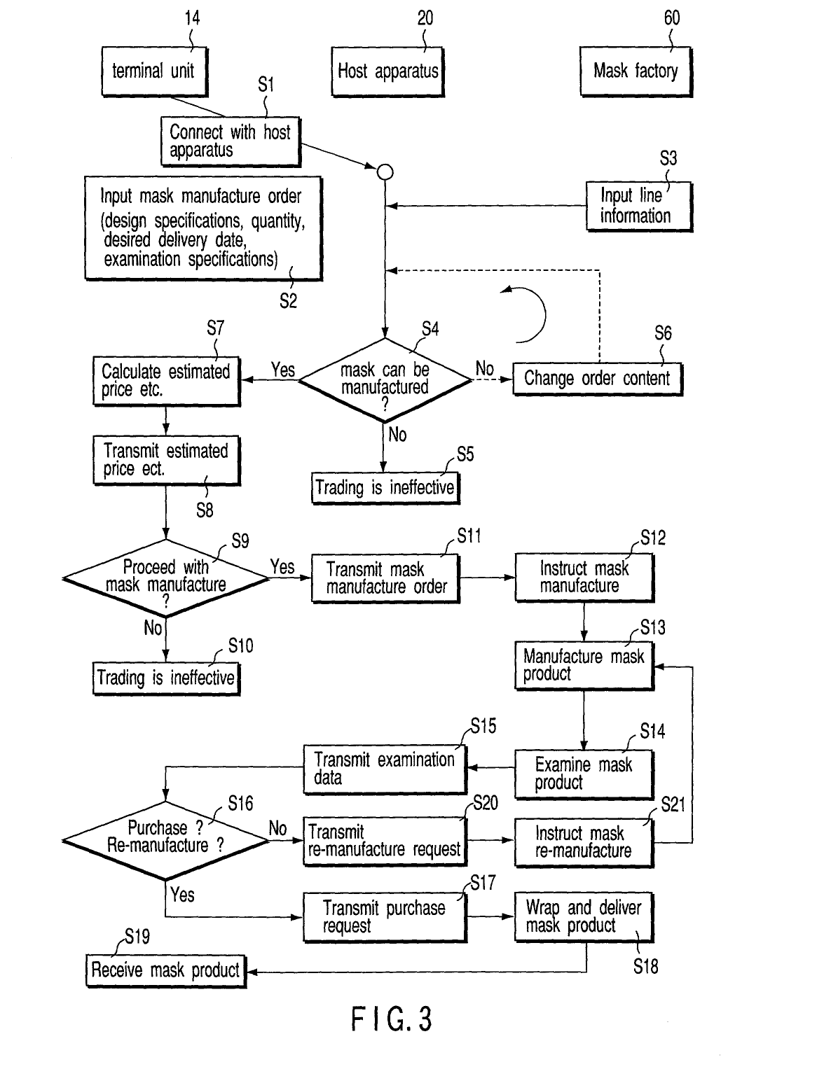

FIGS. 2 and 3 are flowcharts showing a business flow and a system flow, respectively, of a mask trading method performed by the system shown in FIG. 1. An explanation will be given of a mask trading method with reference to FIGS. 2 and 3.

First, a mask buyer connects a user terminal unit 14 to the host apparatus 20 of the mask trading system through the network 12 (steps G1 to G4: step S1). In the flowchart shown in FIG. 2, the connection server 18 is shown to require an ID and a password, when a user terminal unit 14 is connected to the host apparatus 20. In this case, only users with a specific contract are allowed to access the host apparatus 20.

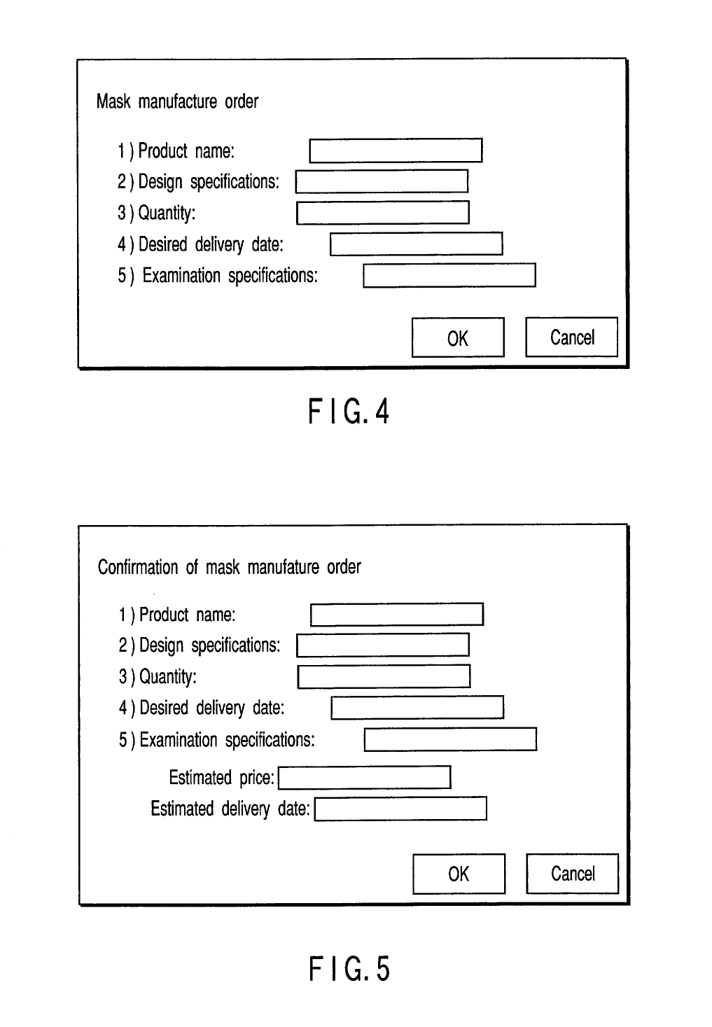

After the user terminal unit 14 is connected to the host apparatus 20, the mask buyer inputs a mask manufacture order including the design specifications, quantity, desired delivery date, examination specifications, and so forth of the ordered mask, through the purchase agent 22 (step G5: step S2). The host apparatus 20 stores the inputted mask manufacture order in the manufacture order file 42 of the database 40. FIG. 4 is a view showing a screen picture displayed for a mask buyer to input a mask manufacture order. In FIG. 4, “Product Name” can be used where product names or product numbers of masks are set in advance between the mask buyer and the mask factory 60. In other words, a product name or product number of a mask is used as information representing specifications of the mask, as the case may be.

On the other hand, line information including the state of the processing abilities of the manufacturing lines is inputted from the mask factory 60 through the factory agent 24, as required (step S3), and is stored in the line information file 44 of the database 40. At this time, price information including the relationships between the contents of mask manufacture orders and mask trading prices has already been stored in the price information file 46 of the database 40.

The line information stored in the line information file 44 may be renewed, for example, every time a mask manufacture order is inputted. More specifically, in this case, when a mask manufacture order is inputted through the purchase agent 22, the host apparatus 20 inquires of the mask factory 60 the latest line information on the mask manufacturing lines. In response to this inquiry, the latest line information is inputted from the mask factory 60 to the factory agent 24. The host apparatus 20 renews the line information in the line information file 44 with the latest line information.

Back to FIG. 3, when the mask manufacture order is inputted, the host apparatus 20 decides whether the ordered mask can be manufactured or not (step S4). Where the mask cannot be manufactured (“No” in step S4), the mask buyer is informed of this fact, and the trading does not come into effect (step S5). Alternatively, where the mask cannot be manufactured (“No” in step S4), the mask buyer is informed of this fact, and may be allowed to change the content of the mask manufacture order (step S6).

Where the mask can be manufactured, the calculating section 26 calculates an estimated price and an estimated delivery date of a mask product, with reference to the price information and the line information (step G6: step S7). The progress selecting section 28 transmits the calculated estimated price and estimated delivery date to the mask buyer through the purchase agent 22 (step S8), and allows the buyer to select whether to proceed with manufacture of the mask or not (step S9).

FIG. 5 is a view showing a screen picture displayed for a mask buyer to select whether to proceed with manufacture of the mask or not. When the mask buyer selects not to proceed with the manufacture (“No” in step S9), the trading does not come into effect (step S10). On the other hand, when the mask buyer selects to proceed with the manufacture (“Yes” in step S9), the manufacture instructing section 32 transmits the mask manufacture order to the data administering section 66 of the mask factory 60 through the factory agent 24 (step G7: step S11).

Upon receiving the mask manufacture order, the data administering section 66 provides the manufacturing line administering section 64 with a manufacture instruction (step S12). On the basis of this, the manufacturing line administering section 64 conducts manufacture of a mask product in the manufacturing lines (step G8: step S13). After the mask product is completed, an examination of the product is performed in the mask factory 60 to form examination data (step G9: step S14). The examination data includes the coordinate positions and dimensions of defects generated in the mask product, and, if necessary, further includes the number of defects and image data thereof. Furthermore, the examination data may include an optical simulation image to be formed when the mask product is used for a wafer.

The data administering section 66 of the mask factory 60 inputs the examination data to the host apparatus 20 through the factory agent 24, while clarifying the relationship of the examination data relative to the corresponding mask manufacture order. The host apparatus 20 stores the inputted examination data in the examination data file 48 of the database 40, and causes the examination data transmitting section 34 to transmit the examination data to the mask buyer through the purchase agent 22 (step G10: step S15). With reference to the examination data, the mask buyer selects whether to buy the mask product or not, and/or whether to re-manufacture the mask or not, through the purchase selecting section 29 and the re-manufacture selecting section 31 of the host apparatus 20 (step G11: step S16).

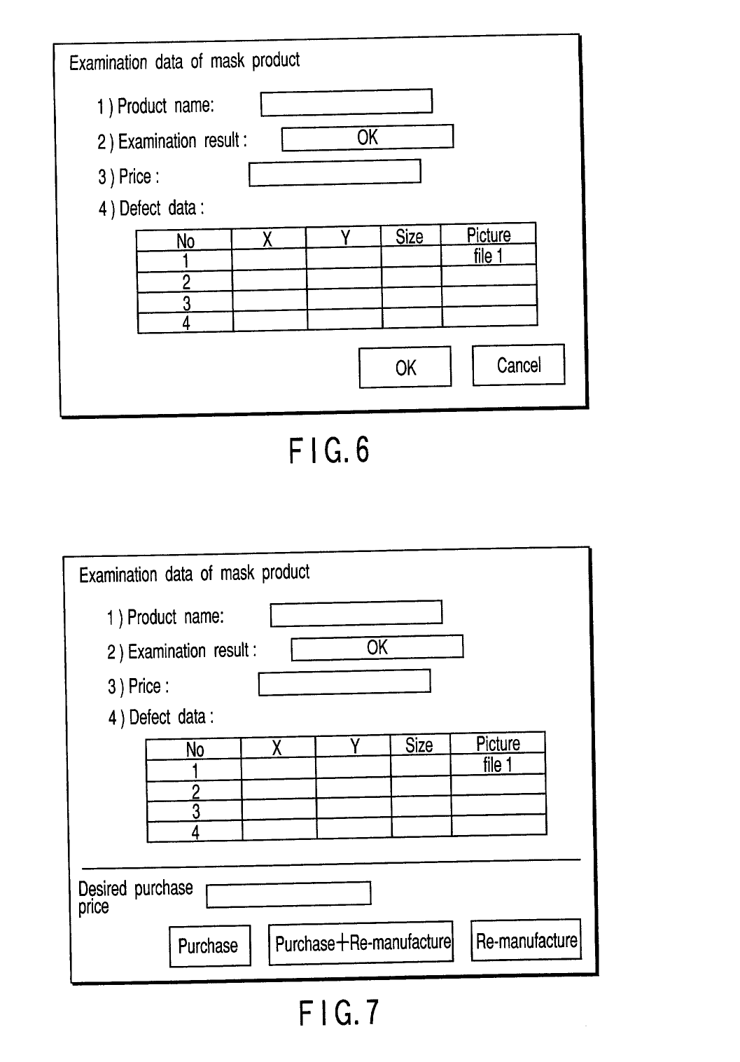

FIG. 6 is a view showing a screen picture displayed for the mask buyer, when the examination results on the mask product conform to the examination specifications set out in the mask manufacture order. In the normal situation, the mask buyer selects the “OK” button (“Yes” in step S16). The host apparatus 20 considers this as a mask purchase request, and transmits it to the mask factory 60 (step G12: step S17). Thereafter, the mask product is wrapped and delivered from the mask factory 60 (step G13: step S18), and then is received by the mask buyer (step G14: step S19), who sequentially pays for the mask. When the mask buyer does not select the “OK” button in the screen picture shown in FIG. 6, it is necessary to take exceptional procedures, and thus their explanation will be omitted.

FIG. 7 is a view showing a screen picture displayed for the mask buyer, when the examination results on the mask product do not conform to the examination specifications set out in the mask manufacture order. As described above, even if the mask product does not conform to the examination specifications, there is a case where defects in the mask product are not transferred onto a semiconductor wafer in a semiconductor manufacturing process, or a case where defects in the mask product are transferred onto a semiconductor wafer in a semiconductor manufacturing process, but cause no problems in the performance of a semiconductor device. Accordingly, even where the mask product does not conform to the examination specifications, it is preferable to give the mask buyer a chance to analyze the examination data. If the defects are in a permissible range, the mask product may be purchased, thereby preventing a waste of mask products.

For this reason, the screen picture shown in FIG. 7 displays, along with the examination data, three selection buttons of “Purchase”, “Purchase +Remanufacture”, and “Re-manufacture”, and a column into which a desired purchase price (a discounted price) of the mask product having defects is inputted. When the mask buyer selects the “Purchase” button without inputting any desired purchase price (“Yes” in step S16), the host apparatus 20 receives this as a mask purchase request, and transmits it to the mask factory 60 (step G12: step S17). When the mask buyer selects the “Purchase” button while inputting a desired purchase price, the host apparatus 20 receives this as a mask purchase request after due consideration by a suitable assessing section, and transmits it to the mask factory 60 (step G12: step S17). In these cases, thereafter, the mask product is wrapped and delivered from the mask factory 60 (step G13: step S18), and then is received by the mask buyer (step G14: step S19), who sequentially pays for the mask.

In the screen picture shown in FIG. 7, when the mask buyer selects the “Re-manufacture” button (“No” in step S16), the host apparatus 20 receives this as a mask re-manufacture order. In this case, the re-manufacture instructing section 33 transmits the mask re-manufacture order to the data administering section 66 of the mask factory 60 through the factory agent 24 (step G15: step S20). Upon receiving the mask manufacture order, the data administering section 66 provides the manufacturing line administering section 64 with a re-manufacture instruction (step G16: step S21). On the basis of this, the manufacturing line administering section 64 conducts re-manufacture of a mask product in the manufacturing lines (step G8: step S13). Then, the steps from the examination step (step G9: step S14) are repeated.

In the screen picture shown in FIG. 7, when the mask buyer selects the “Purchase +Re-manufacture” button, the steps described above after the “Purchase” button is selected, and the steps described above after the “Re-manufacture” button is selected are performed in parallel.

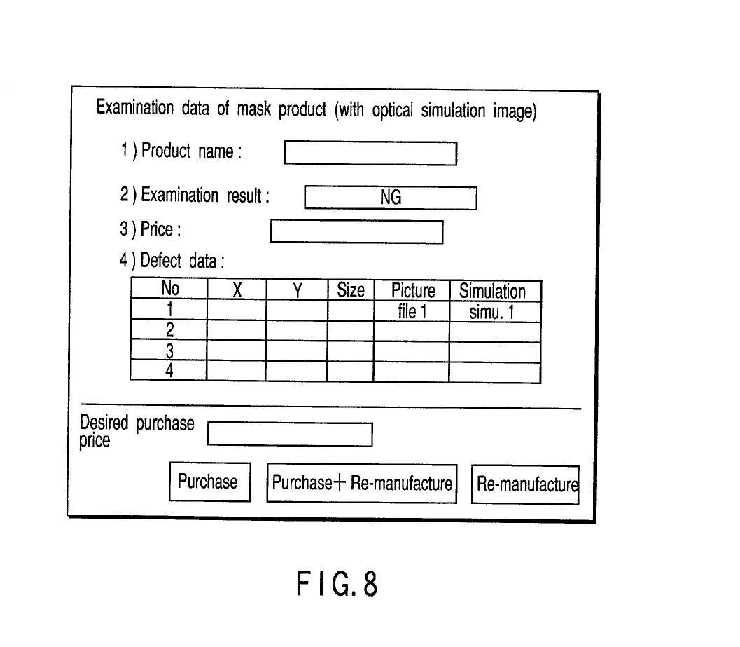

FIG. 8 is a view showing another screen picture displayed for the mask buyer, when the examination results on the mask product do not conform to the examination specifications set out in the mask manufacture order. The examination data in this case further includes an optical simulation image to be formed when the mask product is used for a wafer. The optical simulation image is displayed as another screen picture when the mask buyer clicks on a cell in the “Simulation” column. Where the examination data includes an optical simulation image, the mask buyer is allowed to sufficiently study whether defects formed in the mask product are in a permissible range, when the mask product does not conform to the examination specifications.

In the embodiment described above, although only one mask factory 60 is connected to the host apparatus 20 of the mask trading system, a plurality of mask factories may be connected to the host apparatus 20 in parallel or in series. Where only one mask factory 60 is connected to the host apparatus 20 of the mask trading system, the data administering section 66 of the mask factory 60 and the host apparatus 20 of the mask trading system may be unified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for trading a photo mask used for manufacturing semiconductor devices, comprising:
a purchase mediating section configured to exchange information with a mask buyer through a network;
a factory mediating section configured to exchange information with a mask factory;
a manufacture order storing section configured to store a mask manufacture order, which is inputted through the purchase mediating section, and includes at least one of design specifications, a quantity, a desired delivery date, and examination specifications of a mask;
a line information storing section configured to store line information, which is inputted through the factory mediating section, and includes a processing ability state of a manufacturing line in the mask factory;
a price information storing section configured to store price information, which includes relationships between contents of mask manufacture orders and mask trading prices;
a calculating section configured to calculate an estimated price and an estimated delivery date of a mask product with reference to the price information and the line information, in response to the mask manufacture order;
a progress selecting section configured to transmit the estimated price and the estimated delivery date to the mask buyer through the purchase mediating section, and allow the mask buyer to select whether to proceed with manufacture of the mask or not; and
a manufacture instructing section configured to transmit the mask manufacture order to the mask factory through the factory mediating section, when proceeding with manufacture of the mask is selected.

2. The system according to claim 1, further comprising:
an examination data storing section configured to store examination data of the mask product manufactured in the mask factory, the examination data being inputted through the factory mediating section; and
an examination data transmitting section configured to transmit the examination data to the mask buyer through the purchase mediating section.

3. The system according to claim 2, wherein the examination data includes a coordinate position and a dimension of a defect generated in the mask product.

4. The system according to claim 3, wherein the examination data further includes an optical simulation image of the mask product.

5. The system according to claim 2, further comprising a purchase selecting section configured to allow the mask buyer, through the purchase mediating section, to select, on the basis of the examination data, whether to buy the mask product or not.

6. The system according to claim 5, wherein the purchase selecting section further comprises a portion configured to allow the mask buyer, through the purchase mediating section, to input a desired purchase price of the mask product on the basis of the examination data.

7. The system according to claim 2, further comprising:
a re-manufacture selecting section configured to allow the mask buyer, through the purchase mediating section, to select, on the basis of the examination data, whether to re-manufacture the mask or not; and
a re-manufacture instructing section configured to instruct re-manufacture of the mask to the mask factory through the factory mediating section, when re-manufacture of the mask is selected.

8. The system according to claim 2, further comprising:
a purchase selecting section configured to allow the mask buyer, through the purchase mediating section, to select, on the basis of the examination data, whether to buy the mask product or not; and
a re-manufacture selecting section configured to allow the mask buyer, through the purchase mediating section, to select, on the basis of the examination data, whether to re-manufacture the mask or not,
wherein the mask buyer is allowed to select purchase of the mask and re-manufacture of the mask at the same time.

9. The system according to claim 8, wherein the purchase selecting section further comprises a portion configured to allow the mask buyer, through the purchase mediating section, to input a desired purchase price of the mask product, on the basis of the examination data.

10. The system according to claim 1, wherein the line information stored in the line information storing section is renewed with a latest line information inputted through the factory mediating section every time a mask manufacture order is inputted.

11. A mask trading method of trading a photo mask used for manufacturing semiconductor devices, using a system including a purchase mediating section configured to exchange information with a mask buyer through a network, and a factory mediating section configured to exchange information with a mask factory, the method comprising:
storing a mask manufacture order, which is inputted through the purchase mediating section, and includes at least one of design specifications, a quantity, a desired delivery date, and examination specifications of a mask;
storing line information, which is inputted through the factory mediating section, and includes a processing ability state of a manufacturing line in the mask factory;
storing price information, which includes relationships between contents of mask manufacture orders and mask trading prices;
calculating an estimated price and an estimated delivery date of a mask product with reference to the price information and the line information, in response to the mask manufacture order;
transmitting the estimated price and the estimated delivery date to the mask buyer through the purchase mediating section, and allowing the mask buyer to select whether to proceed with manufacture of the mask or not; and
transmitting the mask manufacture order to the mask factory through the factory mediating section, when proceeding with manufacture of the mask is selected.

12. The method according to claim 11, further comprising:
storing examination data of the mask product manufactured in the mask factory, the examination data being inputted through the factory mediating section; and
transmitting the examination data to the mask buyer through the purchase mediating section.

13. The method according to claim 12, wherein the examination data includes a coordinate position and a dimension of a defect generated in the mask product.

14. The method according to claim 13, wherein the examination data further includes an optical simulation image of the mask product.

15. The method according to claim 12, further comprising allowing the mask buyer, through the purchase mediating section, to select, on the basis of the examination data, whether to buy the mask product or not.

16. The method according to claim 15, further comprising allowing the mask buyer, through the purchase mediating section, to input a desired purchase price of the mask product, on the basis of the examination data.

17. The method according to claim 12, further comprising:
allowing the mask buyer, through the purchase mediating section, to select, on the basis of the examination data, whether to re-manufacture the mask or not; and
instructing re-manufacture of the mask to the mask factory through the factory mediating section, when re-manufacture of the mask is selected.

18. The method according to claim 12, further comprising:
allowing the mask buyer, through the purchase mediating section, to select, on the basis of the examination data, whether to buy the mask product or not; and
allowing the mask buyer, through the purchase mediating section, to select, on the basis of the examination data, whether to re-manufacture the mask or not,
wherein the mask buyer is allowed to select purchase of the mask and re-manufacture of the mask at the same time.

19. The method according to claim 18, further comprising allowing the mask buyer, through the purchase mediating section, to input a desired purchase price of the mask product, on the basis of the examination data.

20. The method according to claim 11, further comprising renewing the line information stored in the line information storing section with a latest line information, which is inputted through the factory mediating section every time a mask manufacture order is inputted.
